(19) United States
(12) Patent Application Publication
(10) Pub. No.: US 2025/0289989 A1
(43) Pub. Date: Sep. 18, 2025

(54) COLD STORAGE MATERIAL COMPOSITION

(71) Applicant: Panasonic Corporation, Osaka (JP)

(72) Inventors: Motohiro SUZUKI, Osaka (JP); Hironobu MACHIDA, Nara (JP)

(21) Appl. No.: 19/222,642

(22) Filed: May 29, 2025

Related U.S. Application Data
(63) Continuation of application No. 17/315,421, filed on May 10, 2021, now abandoned.
Application No. 17/315,421 is a continuation of application No. PCT/JP2019/035116, filed on Sep. 6, 2019.

(30) Foreign Application Priority Data
Mar. 19, 2019 (JP) 2019-050569
Mar. 19, 2019 (JP) 2019-050570

(51) Int. Cl. C09K 5/06; F25D 3/00; F28D 20/02

(52) U.S. Cl. CPC C09K 5/066; F25D 3/00; F28D 20/02

(57) ABSTRACT

A cold storage material composition contains tetra-n-butylammonium bromide, water, and 1-propanol. The weight ratio of tetra-n-butylammonium bromide to water is greater than or equal to 32.5/67.5 and less than or equal to 42.5/57.5. The molar ratio of 1-propanol to water is greater than or equal to 0.02 and less than or equal to 0.042. The cold storage material composition has a fusion heat of greater than or equal to 135 J/g within a range of higher than or equal to 5 degrees Celsius and lower than or equal to 12 degrees Celsius and has a heat flow peak within a range of higher than or equal to 5 degrees Celsius and lower than or equal to 12 degrees Celsius.

### CROSS-REFERENCE OF RELATED APPLICATIONS

This application is a Continuation of U.S. patent application Ser. No. 17/315,421, filed on May 10, 2021, which is a Continuation of International Patent Application No. PCT/JP2019/035116, filed on Sep. 6, 2019, which in turn claims the benefit of Japanese Patent Application No. 2019-050569, filed on Mar. 19, 2019, and Japanese Patent Application No. 2019-050570, filed on Mar. 19, 2019, the entire disclosures of which applications are incorporated by reference herein.

### BACKGROUND

### 1. Technical Field

The present disclosure relates to a cold storage material composition.

### 2. Description of the Related Art

Cold storage material compositions are used for obtaining cooling effect in the fields of, for example, food preservation and medicine. For example, in the event of a power outage, in order to maintain the inside of a refrigerator at a low temperature, a cold storage material composition is placed in the refrigerator.

Japanese Unexamined Patent Application Publication No. 2017-179299 discloses a cold storage material composition in which, during use after cooling, the time of being maintained within an unintended temperature range lower than control temperature before reaching the control temperature is short. This cold storage material composition contains water, a quaternary ammonium salt, and a hydroxy-containing organic compound. The quaternary ammonium salt forms a clathrate hydrate. In the hydroxy-containing organic compound, the number of carbon atoms is 1 to 12, and the number of hydroxy groups is 0.3 to 1.0 times the number of carbon atoms in one molecule. The concentration of the quaternary ammonium salt is lower than the saturated concentration and 15 mass % or more, and the content of the hydroxy-containing organic compound is 2.5 to 16 mass %.

Japanese Unexamined Patent Application Publication No. 2017-179299 discloses in paragraph number 0036 that examples of more preferable combinations of the quaternary ammonium salt and the hydroxy-containing organic compound contained in the cold storage material composition are the following combinations of a material (a) and a material (b):
(a) one or both of tetra-n-butylammonium bromide and tetra-n-butylammonium fluoride; and
(b) at least one selected from the group consisting of methanol, ethanol, 1-propanol, 2-propanol, ethylene glycol, propylene glycol, diethylene glycol, glycerin, sorbitol, mannitol, xylitol, erythritol, glucose, fructose, mannose, arabinose, sucrose, lactose, maltose, trehalose, ascorbic acid, and sodium ascorbate.

Japanese Unexamined Patent Application Publication No. 2007-163045 (in particular, paragraph number 0023) and Japanese Unexamined Patent Application Publication No. 2010-018879 (in particular, paragraph number 0040) disclose that an alcohol is used for decreasing the melting point of tetra-n-butylammonium bromide.

Japanese Patent No. 6226488 discloses a heat storage material in which potassium alum is added to an aqueous solution containing a tetraalkylammonium salt. Japanese Patent No. 4839903 discloses a heat storage material containing tetra-n-butylammonium bromide hydrate, tri-n-butyl-n-pentylammonium bromide hydrate, and tetra-n-butylammonium fluoride.

### SUMMARY

One non-limiting and exemplary embodiment provides a cold storage material composition suitable for a refrigerator or a cold-storage warehouse.

In one general aspect, the techniques disclosed here feature a cold storage material composition containing tetra-n-butylammonium bromide, water, and 1-propanol, wherein the weight ratio of the tetra-n-butylammonium bromide to the water is greater than or equal to 32.5/67.5 and less than or equal to 42.5/57.5; the molar ratio of the 1-propanol to the water is greater than or equal to 0.02 and less than or equal to 0.042; the cold storage material composition has a fusion heat of greater than or equal to 135 J/g within a range of higher than or equal to 5 degrees Celsius and lower than or equal to 12 degrees Celsius; and the cold storage material composition has a heat flow peak within a range of higher than or equal to 5 degrees Celsius and lower than or equal to 12 degrees Celsius.

According to the present disclosure, a cold storage material composition suitable for a refrigerator or a cold storage warehouse can be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a graph showing the results of differential scanning calorimetry of Example B1 and Comparative Example B1;

FIG. 2 is a graph showing the results of differential scanning calorimetry of Example B2 and Comparative Example B1;

FIG. 3 is a graph showing the results of differential scanning calorimetry of Example B3 and Comparative Example B1;

FIG. 4 is a graph showing the results of differential scanning calorimetry of Example B4 and Comparative Example B1;

FIG. 5 is a graph showing the results of differential scanning calorimetry of Example B5 and Comparative Example B1;

FIG. 6 is a graph showing the results of differential scanning calorimetry of Example B6 and Comparative Example B1;

FIG. 7 is a graph showing the results of differential scanning calorimetry of Example B7 and Comparative Example B1;

FIG. 8 is a graph showing the results of differential scanning calorimetry of Example B8 and Comparative Example B1;

FIG. 9 is a graph showing the results of differential scanning calorimetry of Comparative Example B2 and Comparative Example B1;

FIG. 10 is a graph showing the results of differential scanning calorimetry of Comparative Example B7 and Comparative Example B1;

FIG. 11 is a graph showing the results of differential scanning calorimetry of Comparative Example B11 and Comparative Example B1;

FIG. 12 is a graph showing the results of differential scanning calorimetry of Comparative Example B15 and Comparative Example B1;

FIG. 13 is a graph showing the results of differential scanning calorimetry of Comparative Example B20 and Comparative Example B1;

FIG. 14 is a graph showing the results of differential scanning calorimetry of Comparative Example B23 and Comparative Example B1;

FIG. 15 is a graph showing the results of differential scanning calorimetry of Comparative Example B25 and Comparative Example B1;

FIG. 16 is a graph showing the characteristics of a cold storage material during cooling; and

FIG. 17 is a graph showing the characteristics of a cold storage material during warming.

### DETAILED DESCRIPTION

### Definition of Terms

The term “available fusion heat” used in the present specification means a fusion heat within a range of higher than or equal to 5 degrees Celsius and lower than or equal to 12 degrees Celsius.

The term “unavailable fusion heat” used in the present specification means a fusion heat outside the range of higher than or equal to 5 degrees Celsius and lower than or equal to 12 degrees Celsius.

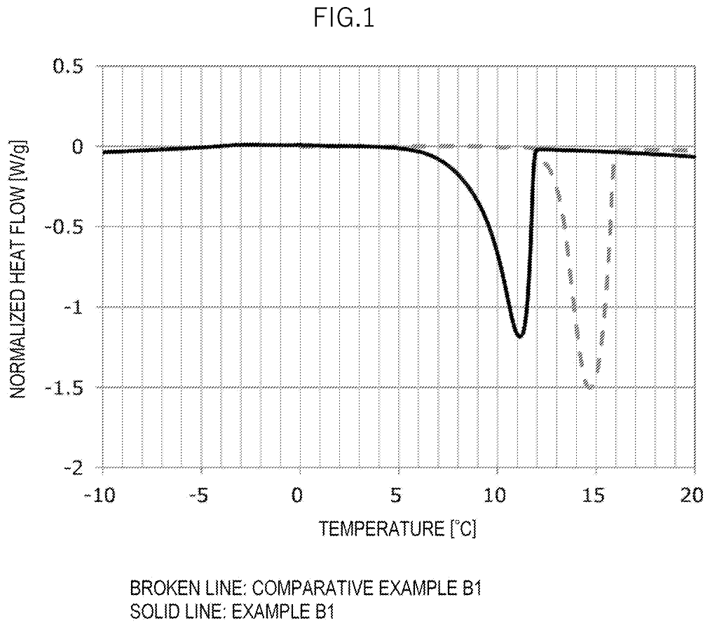

The fusion heat can be, as well known in the technical field of cold storage material compositions, measured with a differential scanning calorimeter (this can be also referred to as “DSC”). As also demonstrated in Examples described below, the differential scanning calories of a cold storage material composition are measured using a differential scanning calorimeter. The results of the differential scanning calorimetry are shown by graphs. See FIGS. 1 to 15. In these graphs, the horizontal axis and the vertical axis indicate the temperature and the normalized heat flow, respectively. The fusion heat within a range of higher than or equal to 5 degrees Celsius and lower than or equal to 12 degrees Celsius is equal to the integrated value of the differential scanning calories within a range of higher than or equal to 5 degrees Celsius and lower than or equal to 12 degrees Celsius in the graphs.

The term “refrigerator” used in the present specification means an electric refrigerator and a portable cooler box of which the insides are cooled. The term “cold-storage warehouse” used in the present specification means a building of which the inside is cooled.

Embodiments of the present disclosure will now be described.

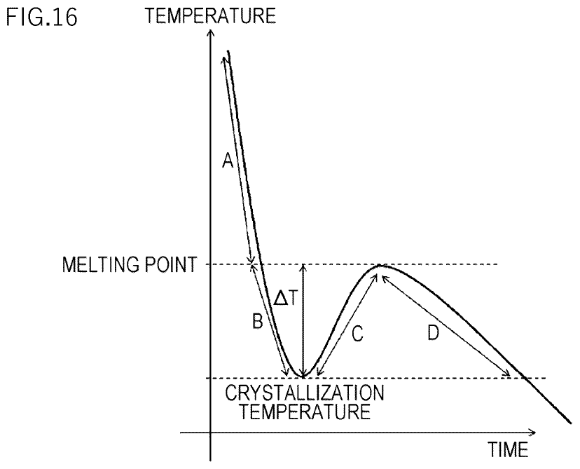

FIG. 16 is a graph showing the characteristics of a cold storage material composition during cooling. In FIG. 16, the horizontal axis and the vertical axis indicate the time and the temperature, respectively.

The cold storage material composition is cooled. See the section A included in FIG. 16. Unlike the case of general liquids, as well known in the technical field of cold storage material compositions, even if the temperature of the cold storage material composition being cooled reaches the melting point thereof, the cold storage material composition does not solidify and becomes a supercooled state. See section B included in FIG. 16. In the supercooled state, the cold storage material composition is a liquid.

Subsequently, the cold storage material composition begins to crystallize spontaneously. With crystallization, the cold storage material composition releases crystallization heat that is almost equal to latent heat. As a result, the temperature of the cold storage material composition begins to increase. See the section C included in FIG. 16. In the present specification, the temperature at which the cold storage material composition begins to crystallize spontaneously is referred to as “crystallization temperature”.

ΔT represents the difference between the melting point and the crystallization temperature of a cold storage material composition. The ΔT can also be called a “degree of supercooling”. The cold storage material composition in the supercooled state becomes clathrate hydrate crystals by crystallization (for example, see Japanese Unexamined Patent Application Publication No. 2017-179299). Here, the clathrate hydrate crystal refers to a crystal formed by wrapping a substance other than water in a cage-like crystal of water molecules formed by hydrogen bonding. Unless otherwise stated, in the present specification, the term “clathrate hydrate crystal” includes not only a clathrate hydrate crystal but also a semi-clathrate hydrate crystal. The semi-clathrate hydrate crystal refers to a crystal formed when guest molecules participate in the hydrogen bond network of water molecules. The concentration at which water molecules and guest molecules form a hydrate crystal in just proportion is referred to as a harmonic concentration. In general, the hydrate crystals are often used around the harmonic concentration.

After completion of release of the crystallization heat of the cold storage material composition with completion of crystallization, the temperature of the cold storage material composition gradually decreases so as to be equal to the ambient temperature. See the section D included in FIG. 16.

The crystallization temperature is lower than the melting point of the cold storage material composition. The melting point of the cold storage material composition can be measured, as well known in the technical field of cold storage material compositions, with a differential scanning calorimeter (this can be also referred to as “DSC”).

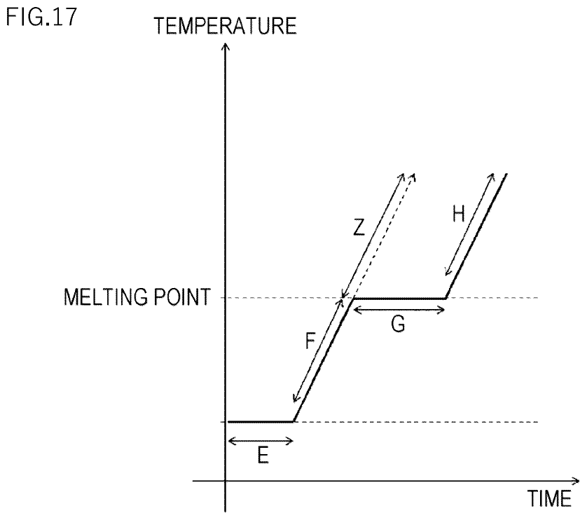

FIG. 17 is a graph showing the characteristics of a cold storage material composition during warming. In FIG. 17, the horizontal axis and the vertical axis indicate the time and the temperature, respectively. The temperature of the cold storage material composition in the section E is maintained at lower than or equal to the crystallization temperature. For example, the temperature of the inside of a refrigerator is set to lower than or equal to the crystallization temperature such that the temperature of the cold storage material composition disposed in the refrigerator is maintained at lower than or equal to the crystallization temperature while the door of the refrigerator is closed.

Subsequently, the cold storage material composition is gradually warmed. See the section F included in FIG. 17. For example, when the door of the refrigerator is opened at the end of the section E (i.e., the start of the section F) (or when the door is opened and a foodstuff is stored), the temperature of the inside for the refrigerator gradually increases.

When the temperature of the cold storage material composition reaches the melting point of the cold storage material composition, the temperature of the cold storage material composition is maintained around the melting point of the cold storage material composition. See the section G included in FIG. 17. If the cold storage material composition is not present, the temperature of the inside of the refrigerator continuously increases as shown in the section Z included in FIG. 17. In contrast, when the cold storage material composition is present, the temperature of the inside of the refrigerator is maintained around the melting point of the cold storage material composition for a certain period of the section G. Thus, the cold storage material composition exhibits the cool storage effect. At the end of the section G, the crystals of the cold storage material composition melt and disappear. Consequently, the cold storage material composition liquefies.

Subsequently, the temperature of the liquefied cold storage material composition increases so as to be equal to the ambient temperature. See the section H included in FIG. 17.

The cold storage material composition is cooled and can be reused. For example, after the door of the refrigerator is closed, as shown by the section A included in FIG. 16, the cold storage material composition is cooled again and is reused.

### First Embodiment

In a first embodiment, a cold storage material composition that is suitably used for a refrigerator should satisfy the following two conditions (BI) and (BII): Condition (BI): the cold storage material composition has a large fusion heat of greater than or equal to 135 J/g within a range of higher than or equal to 5 degrees Celsius and lower than or equal to 12 degrees Celsius; and

Condition (BII): the cold storage material composition has a heat flow peak within a range of higher than or equal to 5 degrees Celsius and lower than or equal to 12 degrees Celsius.

The reason for the conditions (BI) and (B II) is that the temperature of the inside of a refrigerator should be maintained at higher than or equal to about 0 degrees Celsius and lower than or equal to about 12 degrees Celsius (as an example, higher than or equal to 5 degrees Celsius and lower than or equal to 12 degrees Celsius). In other words, if the temperature of the inside of a cooler is maintained at lower than 0 degrees Celsius, such a cooler is not a “refrigerator” but a “freezer”. In contrast, from the viewpoint of food preservation, if the temperature of the inside of a cooler is maintained at higher than 12 degrees Celsius, such a cooler would have little meaning of actual use as a refrigerator.

The cold storage material according to the first embodiment is used for not only a refrigerator but also a cold-storage warehouse.

The cold storage material composition of the first embodiment contains tetra-n-butylammonium bromide, water, and 1-propanol.

If 1-propanol is not contained in the cold storage material composition, as demonstrated in Comparative Example B1, the available fusion heat is equal to 0. Accordingly, a cold storage material composition not containing 1-propanol is unsuitable for a refrigerator or a cold-storage warehouse.

If an alcohol other than 1-propanol is used, as demonstrated in Comparative Examples B2 to B13, the available fusion heat is less than 135 J/g. In this case, since the section G (see FIG. 17) is shorter than that in the cold storage material composition of the first embodiment, the cooling efficiency of the cold storage material composition is lower than the cold storage material composition of the first embodiment.

In the cold storage material composition of the first embodiment, the weight ratio of tetra-n-butylammonium bromide to water is greater than or equal to 32.5/67.5 (i.e., about 0.48) and less than or equal to 42.5/57.5 (i.e., about 0.74).

If the weight ratio is less than 32.5/67.5 (i.e., about 0.48), as demonstrated in Comparative Example B23, the available fusion heat is less than 135 J/g.

Accordingly, in this case, the cooling efficiency of the cold storage material composition is low.

If the weight ratio is greater than 42.5/57.5 (i.e., about 0.74), as demonstrated in Comparative Example B24, the available fusion heat is less than 135 J/g. Accordingly, also in this case, the cooling efficiency of the cold storage material composition is low.

In the cold storage material composition of the first embodiment, the molar ratio of 1-propanol to water is greater than or equal to 0.02 and less than or equal to 0.042.

If the molar ratio is less than 0.02, as demonstrated in Comparative Examples B14 and B15, the available fusion heat is less than 135 J/g. Accordingly, in this case, the cooling efficiency of the cold storage material composition is low.

If the molar ratio is greater than 0.042, as demonstrated in Comparative Examples B16 to B22, the available fusion heat is less than 135 J/g. Accordingly, also in this case, the cooling efficiency of the cold storage material composition is low.

The cold storage material composition of the first embodiment has, as demonstrated in Examples B1 to B8, a fusion heat of greater than or equal to 135 J/g within a range of higher than or equal to 5 degrees Celsius and lower than or equal to 12 degrees Celsius. When the cold storage material composition of the second embodiment is used, the section G (see FIG. 17) is long. Accordingly, the cold storage material composition of the first embodiment has a high cooling efficiency.

The cold storage material composition has a heat flow peak within a range of higher than or equal to 5 degrees Celsius and lower than or equal to 12 degrees Celsius. If a cold storage material composition not having a heat flow peak within a range of higher than or equal to 5 degrees Celsius and lower than or equal to 12 degrees Celsius, like the cold storage material composition of Comparative Example B1, is used, the unavailable fusion heat is larger than the available fusion heat. Accordingly, in this case, since the cooling efficiency within a range of higher than or equal to 5 degrees Celsius and lower than or equal to 12 degrees Celsius is low, the cold storage material composition is unsuitable for a refrigerator or a cold-storage warehouse. In other words, the available fusion heat is decreased as the heat flow peak rises above 12 degrees Celsius or decreases below 5 degrees Celsius. Accordingly, when the cold storage material composition does not have a heat flow peak within a range of higher than or equal to 5 degrees Celsius and lower than or equal to 12 degrees Celsius, the cooling efficiency within a range of higher than or equal to 5 degrees Celsius and lower than or equal to 12 degrees Celsius is low.

### EXAMPLES

The present disclosure will now be described in more detail with reference to the following Examples.

### Example B1

### Method for Manufacturing Cold Storage Material Composition

First, tetra-n-butylammonium bromide (40 g) and water (60 g) were mixed inside a screw tube having a capacity of 110 mL to obtain a mixture liquid. The screw tube was a glass tube with a screw lid.

Next, the mixture liquid (9.58 g) was taken out from the screw tube having a capacity of 110 mL and was then supplied to a screw tube having a capacity of 60 mL. Furthermore, 1-propanol (0.42 g, manufactured by FUJIFILM Wako Pure Chemical Corporation) was added to the screw tube having a capacity of 60 mL. 1-Propanol was used as an additive. Thus, a cold storage material composition according to Example B1 was obtained.

### Measurement Experiment

The cold storage material composition (2 mg) of Example B1 was supplied to a container (obtained from PerkinElmer Co., Ltd., trade name: 02192005). The container was incorporated in a differential scanning calorimeter (obtained from PerkinElmer Co., Ltd., trade name: DSC-8500). The cold storage material composition contained in the container was cooled from an ordinary temperature to −30 degrees Celsius at a rate of 1 degree Celsius/min and was then left to stand at −30 degrees Celsius for 5 minutes to crystallize the cold storage material.

The crystallized cold storage material composition was warmed from −30 degrees Celsius to 30 degrees Celsius at a rate of 1 degree Celsius/min. Thus, the crystallized cold storage material was melted.

During the warming of the crystallized cold storage material composition from −30 degrees Celsius to 30 degrees Celsius at a rate of 1 degree Celsius/min as described above, the differential scanning calorimeter output a heat flow (unit: W).

A normalized heat flow was calculated according to the following mathematical expression:

$$( Normalized heat flow , unit : W / g ) = ( heat flow ) / ( weight of cold storage material , i . e . , 2 mg ) .$$

FIG. 1 is a graph showing the results of the thus-performed differential scanning calorimetry.

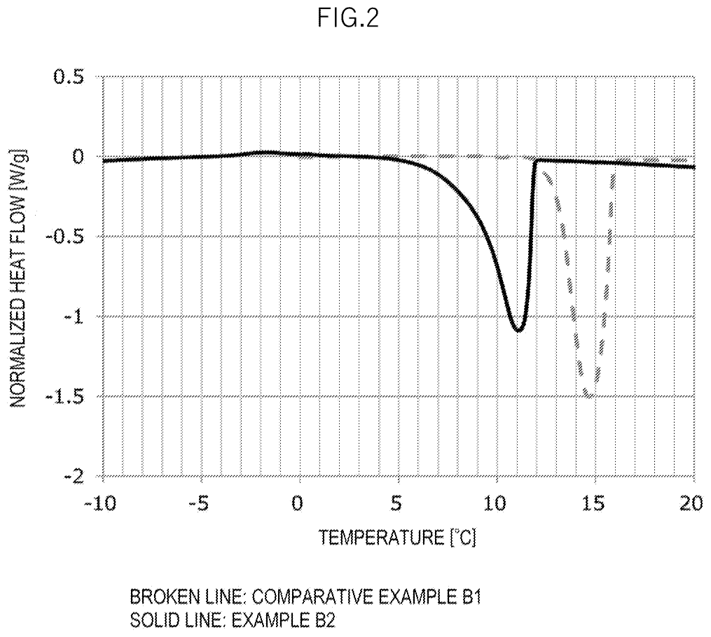

The integrated value of the differential scanning calories within a range of higher than or equal to 5 degrees Celsius and lower than or equal to 12 degrees Celsius in FIG. 1 was calculated as the available fusion heat within a range of higher than or equal to 5 degrees Celsius and lower than or equal to 12 degrees Celsius. See also FIG. 2 in Mohamed Rady et. al., “A Comparative Study of Phase Changing Characteristics of Granular Phase Change Materials Using DSC and T-History Methods”, Tech. Science Press FDMP, vol. 6, no. 2, pp. 137-152, 2010.

Consequently, the cold storage material composition of Example B1 had an available fusion heat of 145.0 J/g.

### Example B2

In Example B2, the same experiment as Example B1 was performed except that the molar ratio of the additive to water was 0.022. FIG. 2 is a graph showing the DSC measurement results in Example B2 and Comparative Example B1.

### Example B3

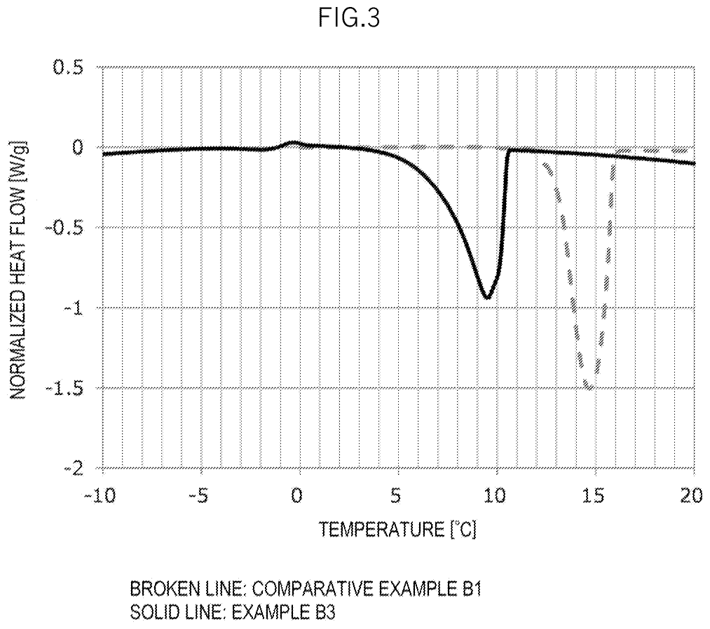

In Example B3, the same experiment as Example B1 was performed except that the molar ratio of the additive to water was 0.035. FIG. 3 is a graph showing the DSC measurement results in Example B3 and Comparative Example B1.

### Example B4

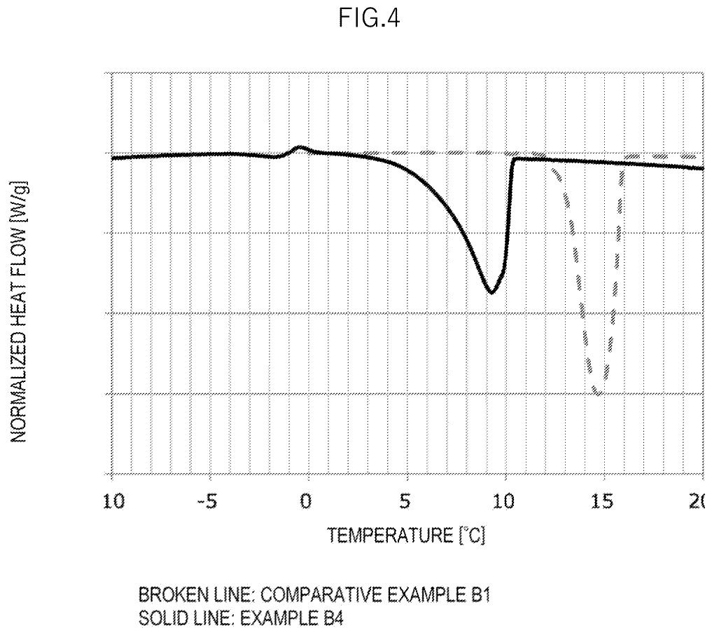

In Example B4, the same experiment as Example B1 was performed except that the molar ratio of the additive to water was 0.04. FIG. 4 is a graph showing the DSC measurement results in Example B4 and Comparative Example B1.

### Example B5

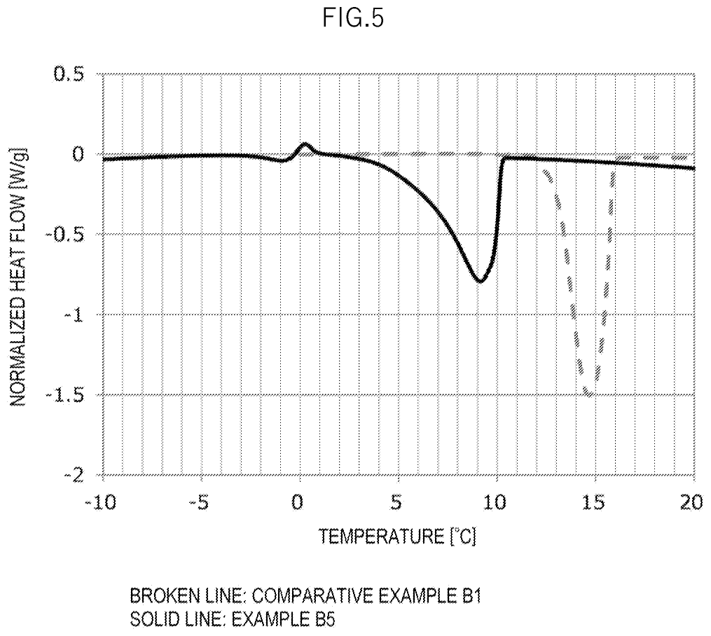

In Example B5, the same experiment as Example B1 was performed except that the molar ratio of the additive to water was 0.042. FIG. 5 is a graph showing the DSC measurement results in Example B5 and Comparative Example B1.

### Example B6

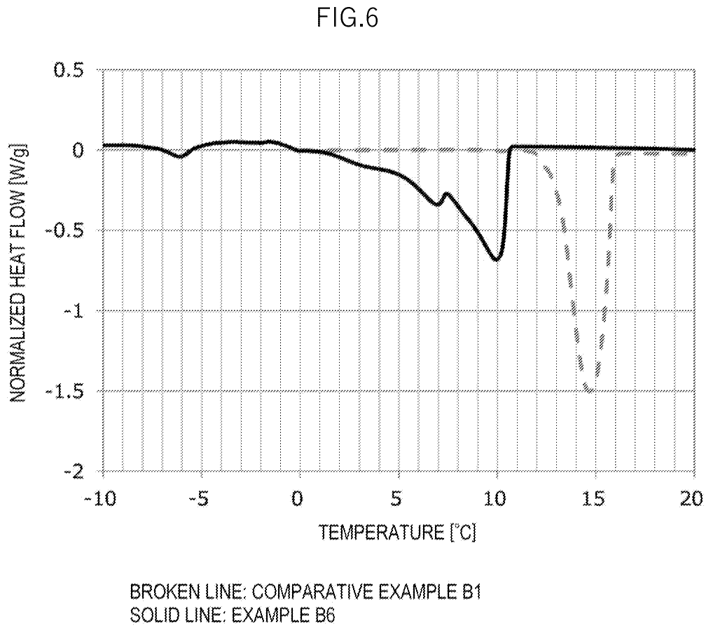

In Example B6, the same experiment as Example B2 was performed except that the weight ratio of tetra-n-butylammonium bromide to water was 32.5/67.5. FIG. 6 is a graph showing the DSC measurement results in Example B6 and Comparative Example B1.

### Example B7

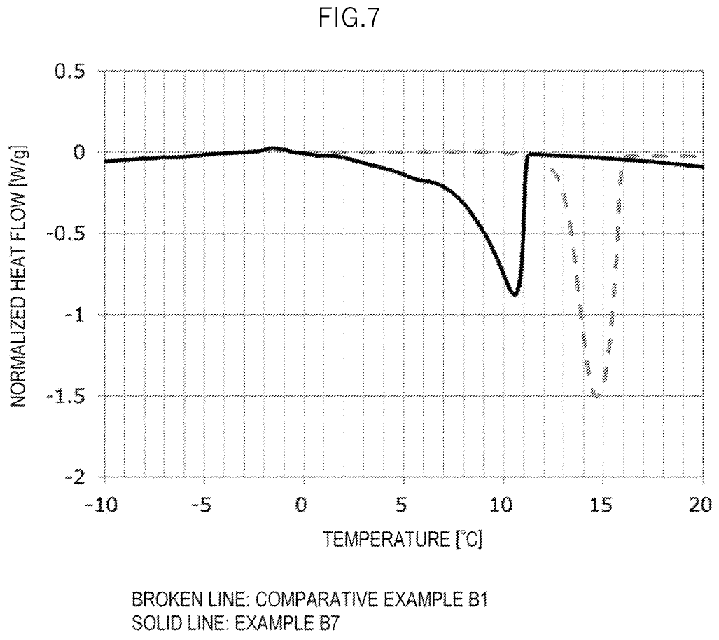

In Example B7, the same experiment as Example B2 was performed except that the weight ratio of tetra-n-butylammonium bromide to water was 35/65. FIG. 7 is a graph showing the DSC measurement results in Example B7 and Comparative Example B1.

### Example B8

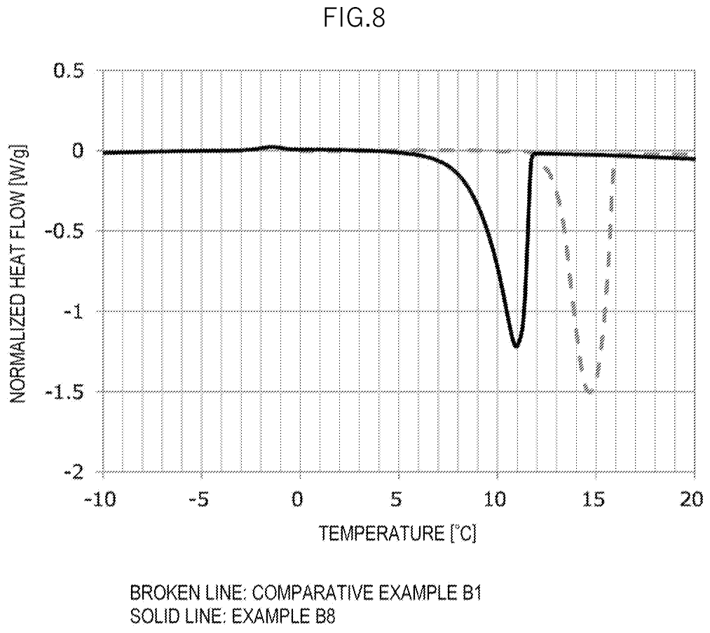

In Example B8, the same experiment as Example B2 was performed except that the weight ratio of tetra-n-butylammonium bromide to water was 42.5/57.5. FIG. 8 is a graph showing the DSC measurement results in Example B8 and Comparative Example B1.

### Comparative Example B1

In Comparative Example B1, the same experiment as Example B1 was performed except that the additive was not added.

### Comparative Example B2

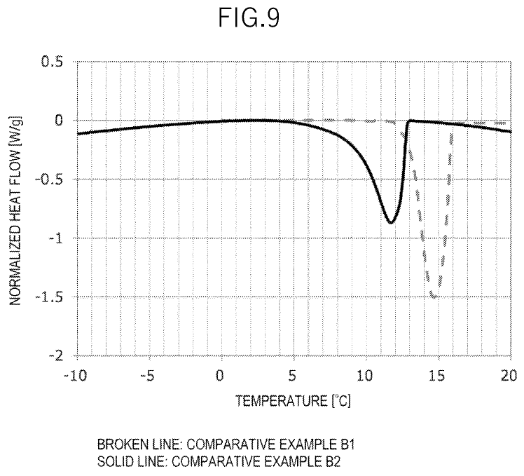

In Comparative Example B2, the same experiment as Example B2 was performed except that methanol (manufactured by FUJIFILM Wako Pure Chemical Corporation) was used as the additive. FIG. 9 is a graph showing the DSC measurement results in Comparative Example B2 and Comparative Example B1.

### Comparative Example B3

In Comparative Example B3, the same experiment as Example B2 was performed except that ethanol (manufactured by FUJIFILM Wako Pure Chemical Corporation) was used as the additive.

### Comparative Example B4

In Comparative Example B4, the same experiment as Example B2 was performed except that 2-propanol (manufactured by FUJIFILM Wako Pure Chemical Corporation) was used as the additive.

### Comparative Example B5

In Comparative Example B5, the same experiment as Example B2 was performed except that 2-butanol (manufactured by FUJIFILM Wako Pure Chemical Corporation) was used as the additive.

### Comparative Example B6

In Comparative Example B6, the same experiment as Example B2 was performed except that tert-butyl alcohol (manufactured by Tokyo Chemical Industry Co., Ltd.) was used as the additive.

### Comparative Example B7

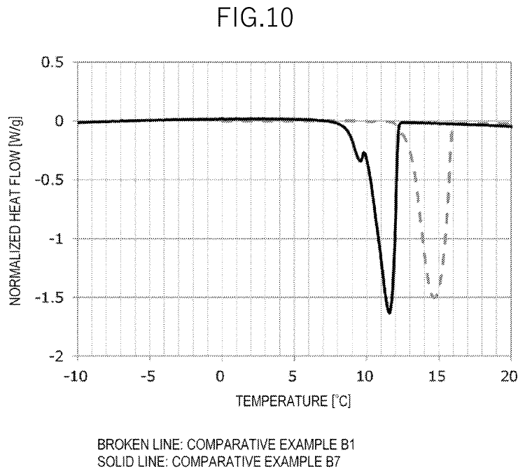

In Comparative Example B7, the same experiment as Example B2 was performed except that 1-pentanol (manufactured by FUJIFILM Wako Pure Chemical Corporation) was used as the additive. FIG. 10 is a graph showing the DSC measurement results in Comparative Example B7 and Comparative Example B1

### Comparative Example B8

In Comparative Example B8, the same experiment as Example B2 was performed except that 1-hexanol (manufactured by FUJIFILM Wako Pure Chemical Corporation) was used as the additive.

### Comparative Example B9

In Comparative Example B9, the same experiment as Example B2 was performed except that ethylene glycol (manufactured by FUJIFILM Wako Pure Chemical Corporation) was used as the additive.

### Comparative Example B10

In Comparative Example BIO, the same experiment as Example B2 was performed except that 1,4-butanediol (manufactured by FUJIFILM Wako Pure Chemical Corporation) was used as the additive.

### Comparative Example B11

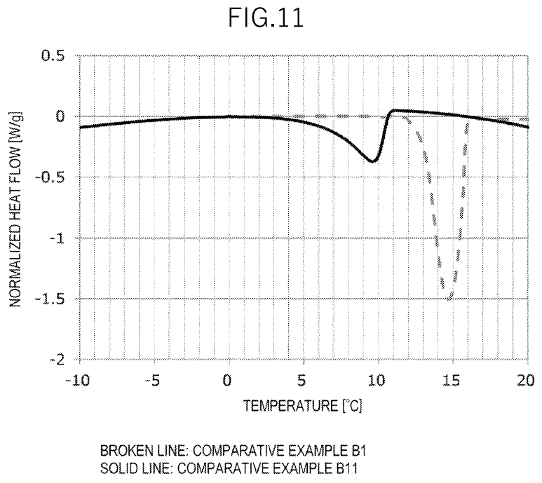

In Comparative Example B 11, the same experiment as Example B2 was performed except that glycerin (manufactured by FUJIFILM Wako Pure Chemical Corporation) was used as the additive. FIG. 11 is a graph showing the DSC measurement results in Comparative Example B 11 and Comparative Example B1.

### Comparative Example B12

In Comparative Example B12, the same experiment as Example B2 was performed except that meso-erythritol (manufactured by Tokyo Chemical Industry Co., Ltd.) was used as the additive.

### Comparative Example B13

In Comparative Example B13, the same experiment as Example B2 was performed except that xylitol (manufactured by FUJIFILM Wako Pure Chemical Corporation) was used as the additive.

### Comparative Example B14

In Comparative Example B14, the same experiment as Example B1 was performed except that the molar ratio of the additive to water was 0.011.

### Comparative Example B15

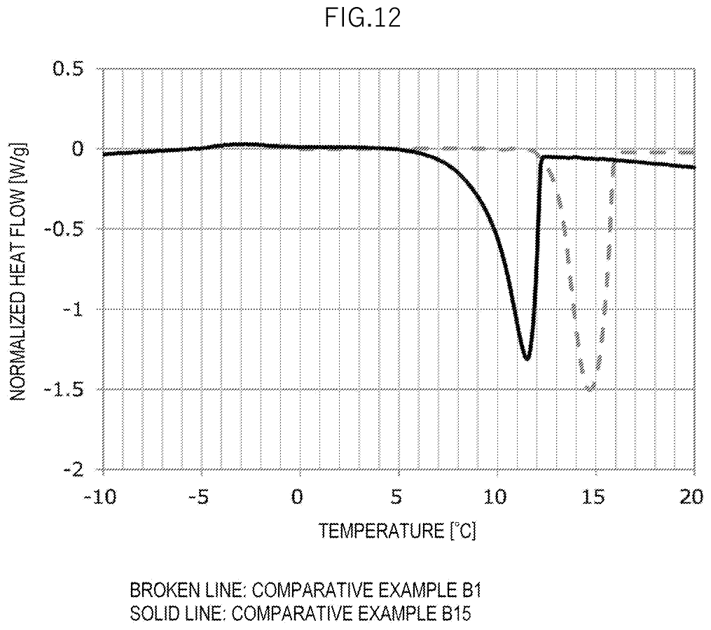

In Comparative Example B15, the same experiment as Example B1 was performed except that the molar ratio of the additive to water was 0.015. FIG. 12 is a graph showing the DSC measurement results in Comparative Example B15 and Comparative Example B1.

### Comparative Example B16

In Comparative Example B16, the same experiment as Example B1 was performed except that the molar ratio of the additive to water was 0.043.

### Comparative Example B17

In Comparative Example B17, the same experiment as Example B1 was performed except that the molar ratio of the additive to water was 0.045.

### Comparative Example B18

In Comparative Example B18, the same experiment as Example B1 was performed except that the molar ratio of the additive to water was 0.047.

### Comparative Example B19

In Comparative Example B 19, the same experiment as Example B1 was performed except that the molar ratio of the additive to water was 0.052.

### Comparative Example B20

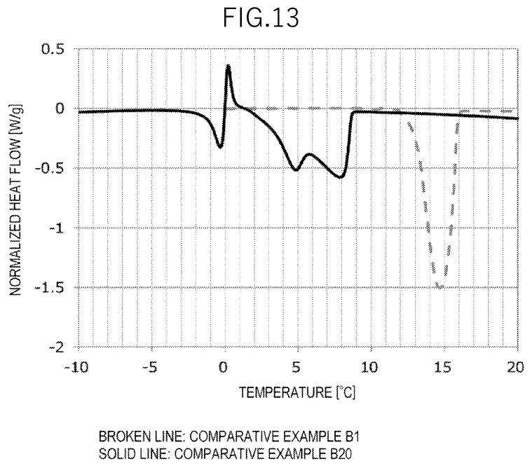

In Comparative Example B20, the same experiment as Example B1 was performed except that the molar ratio of the additive to water was 0.06. FIG. 13 is a graph showing the DSC measurement results in Comparative Example B20 and Comparative Example B1.

### Comparative Example B21

In Comparative Example B21, the same experiment as Example B1 was performed except that the molar ratio of the additive to water was 0.065.

### Comparative Example B22

In Comparative Example B22, the same experiment as Example B1 was performed except that the molar ratio of the additive to water was 0.067.

### Comparative Example B23

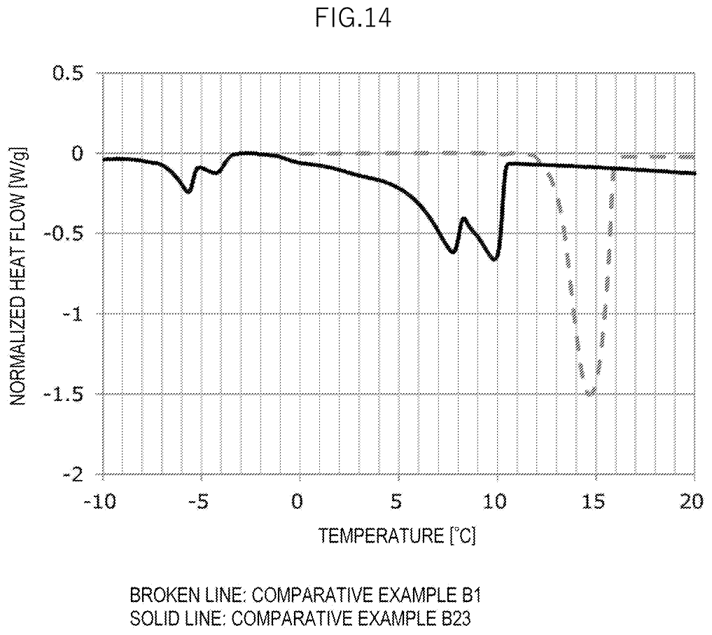

In Comparative Example B23, the same experiment as Example B2 was performed except that the weight ratio of tetra-n-butylammonium bromide to water was 30/70. FIG. 14 is a graph showing the DSC measurement results in Comparative Example B23 and Comparative Example B1.

### Comparative Example B24

In Comparative Example B24, the same experiment as Example B2 was performed except that the weight ratio of tetra-n-butylammonium bromide to water was 45/55.

### Comparative Example B25

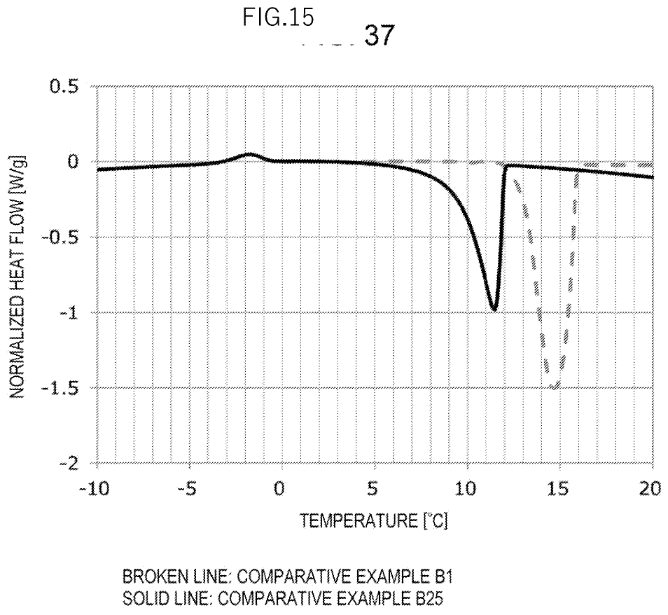

In Comparative Example B25, the same experiment as Example B2 was performed except that the weight ratio of tetra-n-butylammonium bromide to water was 50/50. FIG. 15 is a graph showing the DSC measurement results in Comparative Example B25 and Comparative Example B1.

The following Tables 1 and 2 show the results of Examples B1 to B8 and Comparative Examples B1 to B25.

TABLE 1

| | Weight ratio | | Molar | |
|---|---|---|---|---|
| | of tetra- | | ratio of | Available |
| | n-butylammonium | | additive | fusion heat |
| | bromide to water | Additive | to water | (J/g) |
| Example B1 | 40/60 | 1-Propanol | 0.02 | 145.0 |
| Example B2 | 40/60 | 1-Propanol | 0.022 | 149.3 |
| Example B3 | 40/60 | 1-Propanol | 0.035 | 143.4 |
| Example B4 | 40/60 | 1-Propanol | 0.04 | 140.9 |
| Example B5 | 40/60 | 1-Propanol | 0.042 | 137.9 |
| Example B6 | 32.5/67.5 | 1-Propanol | 0.022 | 136.2 |
| Example B7 | 35/65 | 1-Propanol | 0.022 | 144.5 |
| Example B8 | 42.5/57.5 | 1-Propanol | 0.022 | 142.2 |

TABLE 2

| | Weight ratio of | | Molar | Available |
|---|---|---|---|---|
| | tetra-n- | | ratio of | fusion |
| | butylammonium | | additive | heat |
| | bromide to water | Additive | to water | (J/g) |
| Comparative | 40/60 | (None) | — | 0.0 |
| Example B1 | | | | |
| Comparative | 40/60 | Methanol | 0.022 | 95.7 |
| Example B2 | | | | |
| Comparative | 40/60 | Ethanol | 0.022 | 130.0 |
| Example B3 | | | | |
| Comparative | 40/60 | 2-Propanol | 0.022 | 134.7 |
| Example B4 | | | | |
| Comparative | 40/60 | 2-Butanol | 0.022 | 123.8 |
| Example B5 | | | | |
| Comparative | 40/60 | tert-Butyl | 0.022 | 49.5 |
| Example B6 | | alcohol | | |
| Comparative | 40/60 | 1-Pentanol | 0.022 | 110.7 |
| Example B7 | | | | |
| Comparative | 40/60 | 1-Hexanol | 0.022 | 31.5 |
| Example B8 | | | | |
| Comparative | 40/60 | Ethylene glycol | 0.022 | 109.7 |
| Example B9 | | | | |
| Comparative | 40/60 | 1,4-Butanediol | 0.022 | 107.3 |
| Example B10 | | | | |
| Comparative | 40/60 | Glycerin | 0.022 | 66.7 |
| Example B11 | | | | |
| Comparative | 40/60 | meso-Erythritol | 0.022 | 90.2 |
| Example B12 | | | | |
| Comparative | 40/60 | Xylitol | 0.022 | 104.3 |
| Example B13 | | | | |
| Comparative | 40/60 | 1-Propanol | 0.011 | 68.0 |
| Example B14 | | | | |
| Comparative | 40/60 | 1-Propanol | 0.015 | 126.9 |
| Example B15 | | | | |
| Comparative | 40/60 | 1-Propanol | 0.043 | 133.7 |
| Example B16 | | | | |
| Comparative | 40/60 | 1-Propanol | 0.045 | 129.6 |
| Example B17 | | | | |
| Comparative | 40/60 | 1-Propanol | 0.047 | 125.1 |
| Example B18 | | | | |
| Comparative | 40/60 | 1-Propanol | 0.052 | 112.8 |
| Example B19 | | | | |
| Comparative | 40/60 | 1-Propanol | 0.06 | 97.7 |
| Example B20 | | | | |
| Comparative | 40/60 | 1-Propanol | 0.065 | 94.0 |
| Example B21 | | | | |
| Comparative | 40/60 | 1-Propanol | 0.067 | 91.9 |
| Example B22 | | | | |
| Comparative | 30/70 | 1-Propanol | 0.022 | 130.1 |
| Example B23 | | | | |
| Comparative | 45/55 | 1-Propanol | 0.022 | 124.4 |
| Example B24 | | | | |
| Comparative | 50/50 | 1-Propanol | 0.022 | 90.4 |
| Example B25 | | | | |

As obvious from the comparison of Examples B1 to B 8 with Comparative Example B1, if 1-propanol is not contained in a cold storage material composition, as demonstrated in Comparative Example B1, the available fusion heat is equal to 0.

As obvious from the comparison of Examples B1 to B8 with Comparative Examples B2 to B13, if an alcohol other than 1-propanol is used, the available fusion heat is a value as low as less than or equal to 134.7 J/g.

When the additive is 1-propanol, as obvious from the comparison of Examples B1 to B8 with Comparative Example B23, if the weight ratio of tetra-n-butylammonium bromide to water is 30/70 (i.e., about 0.43), the available fusion heat is a value as low as 130.1 J/g.

When the additive is 1-propanol, as obvious from the comparison of Examples B1 to B8 with Comparative Example B24, if the weight ratio of tetra-n-butylammonium bromide to water is 45/55 (i.e., about 0.82), the available fusion heat is a value as low as 124.4 J/g.

When the additive is 1-propanol, as obvious from the comparison of Examples B1 to B8 with Comparative Examples B14 and B15, if the molar ratio of the additive to water is less than or equal to 0.015, the available fusion heat is a value as low as less than or equal to 126.9 J/g.

When the additive is 1-propanol, as obvious from the comparison of Examples B1 to B8 with Comparative Examples B16 to B22, if the molar ratio of the additive to water is greater than or equal to 0.043, the available fusion heat is a value as low as less than or equal to 133.7 J/g. As demonstrated in Examples B1 to B8, when the additive is 1-propanol and the following two conditions (Bi) and (Bii) are satisfied, a cold storage material composition having a fusion heat of greater than or equal to 135 J/g within a range of higher than or equal to 5 degrees Celsius and lower than or equal to 12 degrees Celsius can be obtained.

Condition (Bi): the weight ratio of tetra-n-butylammonium bromide to water is greater than or equal to 32.5/67.5 and less than or equal to 42.5/57.5; and

Condition (Bii): the molar ratio of 1-propanol to water is greater than or equal to 0.02 and less than or equal to 0.042.

As obvious from FIGS. 1 to 15, each of the cold storage material compositions of Examples B1 to B8 has a heat flow peak within a range of higher than or equal to 5 degrees Celsius and lower than or equal to 12 degrees Celsius. In contrast, the cold storage material composition of Comparative Example B1 has a heat flow peak at about 14.5 degrees Celsius.

A cold storage material composition according to a first aspect of the present disclosure can be included in a refrigerator or a cold-storage warehouse, the internal temperature of which is maintained at higher than or equal to 5 degrees Celsius and lower than or equal to 12 degrees Celsius.

What is claimed is:

1. A cold storage material composition comprising:
tetra-n-butylammonium bromide;
water; and
1-propanol, wherein
a weight ratio of the tetra-n-butylammonium bromide to the water is greater than or equal to 32.5/67.5 and less than or equal to 42.5/57.5;
a molar ratio of the 1-propanol to the water is greater than or equal to 0.02 and less than or equal to 0.042;
the cold storage material composition has a fusion heat of greater than or equal to 135 J/g within a range of higher than or equal to 5 degrees Celsius and lower than or equal to 12 degrees Celsius; and
the cold storage material composition has a heat flow peak within a range of higher than or equal to 5 degrees Celsius and lower than or equal to 12 degrees Celsius.

2. A refrigerator including the cold storage material composition according to claim 1.

3. A cold-storage warehouse including the cold storage material composition according to claim 1.
